(19) United States
(12) Patent Application Publication
(10) Pub. No.: US 2024/0160000 A1
(43) Pub. Date: May 16, 2024

(54) COVERSLIPPING METHOD

(71) Applicant: SCOPIO LABS LTD., Tel Aviv (IL)

(72) Inventors: Ben LESHEM, Tel Aviv (IL); Erez NA'AMAN, Tel Aviv (IL); Eran SMALL, Yehud (IL); Ben SARUSI, Ramla (IL)

(73) Assignee: SCOPIO LABS LTD., Tel Aviv (IL)

(21) Appl. No.: 18/559,473

(22) PCT Filed: May 26, 2022
(86) PCT No.: PCT/IL2022/050565

§ 371 Date: Nov. 7, 2023

Related U.S. Application Data
(60) Provisional application No. 63/202,105, filed on May 27, 2021.

(51) Int. Cl. G02B 21/34; G01N 1/30

(52) U.S. Cl. CPC G02B 21/34; G01N 1/30

(57) ABSTRACT

A microscope system may be integrated with a coverslipping device. A method of preparing a microscope slide for imaging a sample on the microscope slide may include placing a transparent flowable material on the sample while the slide is supported with one or more linkages coupled to a processor, covering the sample with a coverslip, and placing the microscope slide on a microscope stage with the one or more linkages coupled to the slide and the processor. Various other systems and methods are provided.

### RELATED APPLICATIONS

This application claims the benefit under 35 U.S.C. § 119(e) of U.S. Provisional Patent Application No. 63/202,105, filed May 27, 2021, entitled “COVERSLIPPING METHOD,” which is incorporated, in its entirety, by this reference.

### BACKGROUND

Many microscopies and diagnostic applications require coverslipping microscope slides. Conventional microscopy may require coverslipping to ensure compatibility with the microscope's imaging optics, such as the objective lens and tube lens, to improve image quality as well as protect or preserve the sample itself. For instance, the mounting medium used to connect the coverslip to the microscope slide may match the refractive index in different parts of the sample and reduce the refraction index variation relative to a dry, fixed sample. Computational microscopy may use this reduction of the refraction index variation to produce betterimage quality. In many computational microscopy applications, the phase of the sample may be an important factor. Because the phase may be closely related to the refraction index, the lack of a mounting medium may cause significant image deterioration. For example, Fourier ptychography microscopy (FPM) may be affected by the lack of a mounting medium, resulting in a poor image quality with visible artifacts. In general, the phase may be more important for coherent or quasi-coherent imaging applications, of which FPM is a special case, and the mounting medium may perform phase matching for the sample to reduce image degrading artifacts.

Coverslipping methods typically use a glue as a mounting medium. Using glue may have the advantage of preserving the slide and the sample for a long period of time. However, glue has several disadvantages. The glue may take a relatively long time to spread and dry, for instance taking over a minute and often much longer (typically 10 minutes or longer to dry). The glue may include toxic or otherwise hazardous elements that may be released into the air while drying. In addition, the glue may be difficult to remove from the sample, which may be needed in certain cases.

Coverslipping may be performed manually, or in some cases by a dedicated automatic device. A whole slide scanner, which may scan a large number of slides in an automated fashion, may often use slides coverslipped by an automatic coverslipping device. However, they may be disconnected and therefore require manual steps which may slow down the processes. Due to the disadvantages of using glue as the mounting medium, using glue in an automatic coverslipping device may present additional challenges. In light of the above, it may be desirable to improve coverslipping methods that may also be readily adaptable to an automatic coverslipping device.

### SUMMARY

The presently disclosed systems, methods and apparatuses provide improved techniques for coverslipping. In some embodiments, a transparent flowable material, such as an oil, may be used as a mounting medium for coverslipping. The presently disclosed systems, methods, and apparatuses may provide improved coverslipping by placing a transparent flowable material on a sample on a slide while the slide is supported with one or more linkages coupled to a processor. After covering the sample with a coverslip, the slide may be placed on a microscope stage using the linkages coupled to the slide and the processor. In some embodiments, the coverslipping technique may be adapted to an apparatus, such as an automatic coverslipping device coupled to a microscope.

In some embodiments, a method of preparing a microscope slide for imaging a sample on the slide may include placing an oil on the sample, covering the sample with a coverslip, and allowing the oil to spread over the sample between the sample and the coverslip.

### INCORPORATION BY REFERENCE

All patents, applications, and publications referred to and identified herein are hereby incorporated by reference in their entirety and shall be considered fully incorporated by reference even though referred to elsewhere in the application.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 shows a diagram of an exemplary microscope, in accordance with some embodiments;

FIG. 2A shows a diagram of an exemplary coverslipping system, in accordance with some embodiments;

FIG. 2B shows a drawing of an exemplary housing for a coverslipping system, in accordance with some embodiments;

FIG. 3 shows a drawing of an exemplary cassette in a coverslipping system, in accordance with some embodiments;

FIG. 4 shows a drawing of an exemplary coverslipping station in a coverslipping system, in accordance with some embodiments;

FIG. 5 shows a drawing of an exemplary coverslipping station in a coverslipping system, in accordance with some embodiments;

FIG. 6 shows a drawing of placing slides in an exemplary coverslipping system, in accordance with some embodiments;

FIG. 7 shows a flow chart of an exemplary method, in accordance with some embodiments;

FIG. 8 shows an exemplary computing system, in accordance with some embodiments; and

FIG. 9 shows an exemplary network architecture, in accordance with some embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

The presently disclosed systems, methods and apparatuses are well suited for combination with prior approaches to analyzing samples such as blood samples. For example, the optical scanning apparatus may comprise one or more components of a conventional microscope with a sufficient numerical aperture, or a computational microscope as described in U.S. patent application Ser. No. 15/775,389, filed on Nov. 10, 2016, entitled “Computational microscopes and methods for generating an image under different illumination conditions,” published as US20190235224. The system may comprise one or more components of an autofocus system, for example as described in U.S. Pat. No. 10,705,326, entitled “Autofocus system for a computational microscope”. While the system may comprise any suitable user interface and data storage, in some embodiments, the system comprises one or more components for data storage and user interaction as described in U.S. Pat. No. 10,935,779, entitled “Digital microscope which operates as a server”. The system may comprise one or more components of an autoloader for loading slides, for example as described in U.S. patent application Ser. No. 16/875,665, filed on May 15, 2020, entitled “Multi/parallel scanner”. The system may comprise one or more components for selectively scanning areas of a sample, for example as described in U.S. patent application Ser. No. 16/875,721, filed on May 15, 2020, entitled “Accelerating digital microscopy scans using empty/dirty area detection,” published as US20200278530. The system may comprise a grid with a known pattern to facilitate image reconstruction, for example as described in U.S. Pat. No. 10,558,029, entitled “System for image reconstruction using a known pattern”.

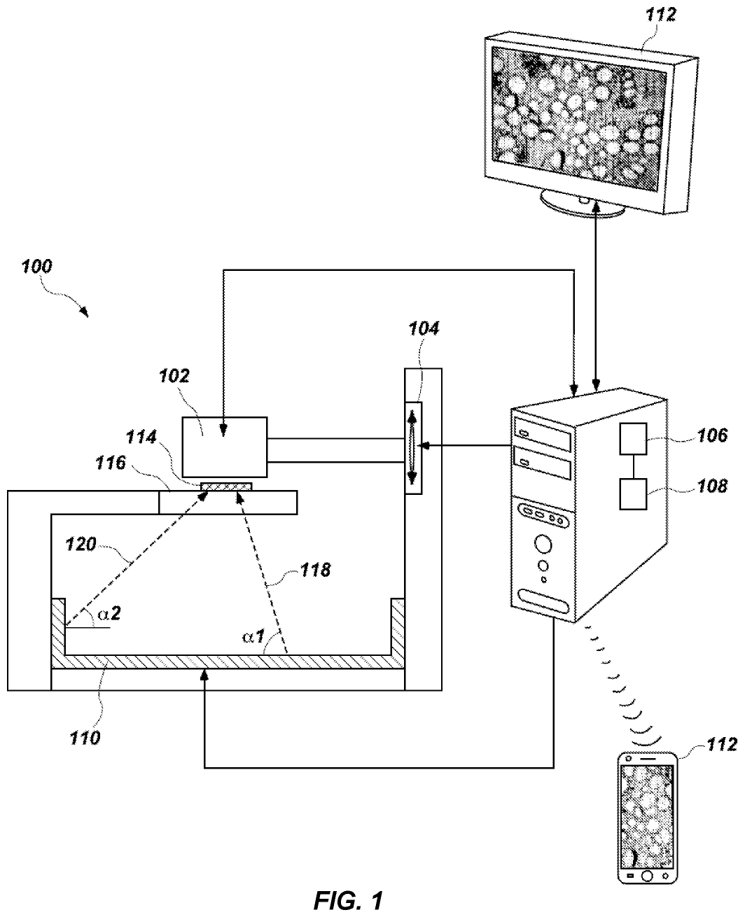

FIG. 1 is a diagrammatic representation of a microscope 100 consistent with the exemplary disclosed embodiments. The term “microscope” as used herein generally refers to any device or instrument for magnifying an object which is smaller than easily observable by the naked eye, i.e., creating an image of an object for a user where the image is larger than the object. One type of microscope may be an “optical microscope” that uses light in combination with an optical system for magnifying an object. An optical microscope may be a simple microscope having one or more magnifying lens. Another type of microscope may be a “computational microscope” that comprises an image sensor and image-processing algorithms to enhance or magnify the object's size or other properties. The computational microscope may be a dedicated device or created by incorporating software and/or hardware with an existing optical microscope to produce high-resolution digital images. As shown in FIG. 1, microscope 100 comprises an image capture device 102, a focus actuator 104, a controller 106 connected to memory 108, an illumination assembly 110, and a user interface 112. An example usage of microscope 100 may be capturing images of a sample 114 mounted on a stage 116 located within the field-of-view (FOV) of image capture device 102, processing the captured images, and presenting on user interface 112 a magnified image of sample 114.

Image capture device 102 may be used to capture images of sample 114. In this specification, the term “image capture device” as used herein generally refers to a device that records the optical signals entering a lens as an image or a sequence of images. The optical signals may be in the near-infrared, infrared, visible, and ultraviolet spectrums. Examples of an image capture device comprise a CCD camera, a CMOS camera, a color camera, a photo sensor array, a video camera, a mobile phone equipped with a camera, a webcam, a preview camera, a microscope objective and detector, etc. Some embodiments may comprise only a single image capture device 102, while other embodiments may comprise two, three, or even four or more image capture devices 102. In some embodiments, image capture device 102 may be configured to capture images in a defined field-of-view (FOV). Also, when microscope 100 comprises several image capture devices 102, image capture devices 102 may have overlap areas in their respective FOVs. Image capture device 102 may have one or more image sensors (not shown in FIG. 1) for capturing image data of sample 114. In other embodiments, image capture device 102 may be configured to capture images at an image resolution higher than VGA, higher than 1 Megapixel, higher than 2 Megapixels, higher than 5 Megapixels, 10 Megapixels, higher than 12 Megapixels, higher than 15 Megapixels, or higher than 20 Megapixels. In addition, image capture device 102 may also be configured to have a pixel size smaller than 15 micrometers, smaller than 10 micrometers, smaller than 5 micrometers, smaller than 3 micrometers, or smaller than 1.6 micrometer.

In some embodiments, microscope 100 comprises focus actuator 104. The term “focus actuator” as used herein generally refers to any device capable of converting input signals into physical motion for adjusting the relative distance between sample 114 and image capture device 102. Various focus actuators may be used, including, for example, linear motors, electrostrictive actuators, electrostatic motors, capacitive motors, voice coil actuators, magnetostrictive actuators, etc. In some embodiments, focus actuator 104 may comprise an analog position feedback sensor and/or a digital position feedback element. Focus actuator 104 is configured to receive instructions from controller 106 in order to make light beams converge to form a clear and sharply defined image of sample 114. In the example illustrated in FIG. 1, focus actuator 104 may be configured to adjust the distance by moving image capture device 102.

However, in other embodiments, focus actuator 104 may be configured to adjust the distance by moving stage 116, or by moving both image capture device 102 and stage 116. Microscope 100 may also comprise controller 106 for controlling the operation of microscope 100 according to the disclosed embodiments. Controller 106 may comprise various types of devices for performing logic operations on one or more inputs of image data and other data according to stored or accessible software instructions providing desired functionality. For example, controller 106 may comprise a central processing unit (CPU), support circuits, digital signal processors, integrated circuits, cache memory, or any other types of devices for image processing and analysis such as graphic processing units (GPUs). The CPU may comprise any number of microcontrollers or microprocessors configured to process the imagery from the image sensors. For example, the CPU may comprise any type of single- or multi-core processor, mobile device microcontroller, etc. Various processors may be used, including, for example, processors available from manufacturers such as Intel®, AMD®, etc. and may comprise various architectures (e.g., x86 processor, ARM®, etc.). The support circuits may be any number of circuits generally well known in the art, including cache, power supply, clock and input-output circuits. Controller 106 may be at a remote location, such as a computing device communicatively coupled to microscope 100.

In some embodiments, controller 106 may be associated with memory 108 used for storing software that, when executed by controller 106, controls the operation of microscope 100. In addition, memory 108 may also store electronic data associated with operation of microscope 100 such as, for example, captured or generated images of sample 114. In one instance, memory 108 may be integrated into the controller 106. In another instance, memory 108 may be separated from the controller 106.

Specifically, memory 108 may refer to multiple structures or computer-readable storage mediums located at controller 106 or at a remote location, such as a cloud server. Memory 108 may comprise any number of random-access memories, read only memories, flash memories, disk drives, optical storage, tape storage, removable storage and other types of storage.

Microscope 100 may comprise illumination assembly 110. The term “illumination assembly” as used herein generally refers to any device or system capable of projecting light to illuminate sample 114.

Illumination assembly 110 may comprise any number of light sources, such as light emitting diodes (LEDs), LED array, lasers, and lamps configured to emit light, such as a halogen lamp, an incandescent lamp, or a sodium lamp. For example, illumination assembly 110 may comprise a Kohler illumination source. Illumination assembly 110 may be configured to emit polychromatic light. For instance, the polychromatic light may comprise white light.

In some embodiments, illumination assembly 110 may comprise only a single light source. Alternatively, illumination assembly 110 may comprise four, sixteen, or even more than a hundred light sources organized in an array or a matrix. In some embodiments, illumination assembly 110 may use one or more light sources located at a surface parallel to illuminate sample 114. In other embodiments, illumination assembly 110 may use one or more light sources located at a surface perpendicular or at an angle to sample 114.

In addition, illumination assembly 110 may be configured to illuminate sample 114 in a series of different illumination conditions. In one example, illumination assembly 110 may comprise a plurality of light sources arranged in different illumination angles, such as a two-dimensional arrangement of light sources. In this case, the different illumination conditions may comprise different illumination angles. For example, FIG. 1 depicts a beam 118 projected from a first illumination angle α1, and a beam 120 projected from a second illumination angle α2. In some embodiments, first illumination angle α1 and second illumination angle α2 may have the same value but opposite sign. In other embodiments, first illumination angle α1 may be separated from second illumination angle α2. However, both angles originate from points within the acceptance angle of the optics. In another example, illumination assembly 110 may comprise a plurality of light sources configured to emit light in different wavelengths. In this case, the different illumination conditions may comprise different wavelengths. For instance, each light source may be configured to emit light with a full width half maximum bandwidth of no more than 50 nm so as to emit substantially monochromatic light. In yet another example, illumination assembly 110 may be configured to use a number of light sources at predetermined times. In this case, the different illumination conditions may comprise different illumination patterns. For example, the light sources may be arranged to sequentially illuminate the sample at different angles to provide one or more of digital refocusing, aberration correction, or resolution enhancement. Accordingly and consistent with the present disclosure, the different illumination conditions may be selected from a group including: different durations, different intensities, different positions, different illumination angles, different illumination patterns, different wavelengths, or any combination thereof.

Although reference is made to computational microscopy, the presently disclosed systems and methods are well suited for use with many types of microscopy and microscopes such as one or more of a high definition microscope, a digital microscope, a scanning digital microscope, a 3D microscope, a phase imaging microscope, a phase contrast microscope, a dark field microscope, a differential interference contrast microscope, a light-sheet microscope, a confocal microscope, a holographic microscope, or a fluorescence-based microscope.

In some embodiments, image capture device 102 may have an effective numerical aperture (“NA”) of at least 0.8. In some embodiments, the effective NA corresponds to a resolving power of the microscope that has the same resolving power as an objective lens with that NA. Image capture device 102 may also have an objective lens with a suitable NA to provide the effective NA, although the NA of the objective lens may be less than the effective NA of the microscope. For example, the imaging apparatus may comprise a computational microscope to reconstruct an image from a plurality of images captured with different illumination angles as described herein, in which the reconstructed image corresponds to an effective NA that is higher than the NA of the objective lens of the image capture device. In some embodiments with conventional microscopes, the NA of the microscope objective corresponds to the effective NA of the images. The lens may comprise any suitable lens such as an oil immersion lens or a non-oil immersion lens.

Consistent with disclosed embodiments, microscope 100 may comprise, be connected with, or in communication with (e.g., over a network or wirelessly, e.g., via Bluetooth) user interface 112. The term “user interface” as used herein generally refers to any device suitable for presenting a magnified image of sample 114 or any device suitable for receiving inputs from one or more users of microscope 100. FIG. 1 illustrates two examples of user interface 112. The first example is a smartphone or a tablet wirelessly communicating with controller 106 over a Bluetooth, cellular connection or a Wi-Fi connection, directly or through a remote server. The second example is a PC display physically connected to controller 106. In some embodiments, user interface 112 may comprise user output devices, including, for example, a display, tactile device, speaker, etc. In other embodiments, user interface 112 may comprise user input devices, including, for example, a touchscreen, microphone, keyboard, pointer devices, cameras, knobs, buttons, etc. With such input devices, a user may be able to provide information inputs or commands to microscope 100 by typing instructions or information, providing voice commands, selecting menu options on a screen using buttons, pointers, or eye-tracking capabilities, or through any other suitable techniques for communicating information to microscope 100. User interface 112 may be connected (physically or wirelessly) with one or more processing devices, such as controller 106, to provide and receive information to or from a user and process that information. In some embodiments, such processing devices may execute instructions for responding to keyboard entries or menu selections, recognizing and interpreting touches and/or gestures made on a touchscreen, recognizing and tracking eye movements, receiving and interpreting voice commands, etc.

Microscope 100 may also comprise or be connected to stage 116. Stage 116 comprises any horizontal rigid surface where sample 114 may be mounted for examination. Stage 116 may comprise a mechanical connector for retaining a slide containing sample 114 in a fixed position. The mechanical connector may use one or more of the following: a mount, an attaching member, a holding arm, a clamp, a clip, an adjustable frame, a locking mechanism, a spring or any combination thereof. In some embodiments, stage 116 may comprise a translucent portion or an opening for allowing light to illuminate sample 114. For example, light transmitted from illumination assembly 110 may pass through sample 114 and towards image capture device 102. In some embodiments, stage 116 and/or sample 114 may be moved using motors or manual controls in the XY plane to enable imaging of multiple areas of the sample.

The present disclosure provides for coverslipping systems and methods that may avoid the challenges of using glue as a mounting medium and allow for faster, more efficient, and adaptable coverslipping in a relatively small form-factor device. For example, an automatic coverslipping device may be integrated with or otherwise combined with a microscope.

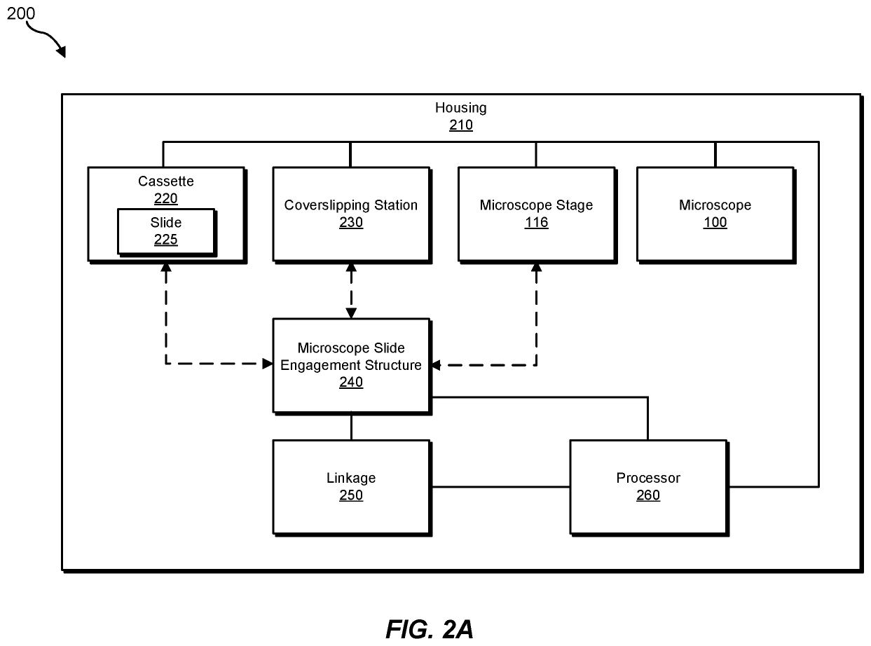

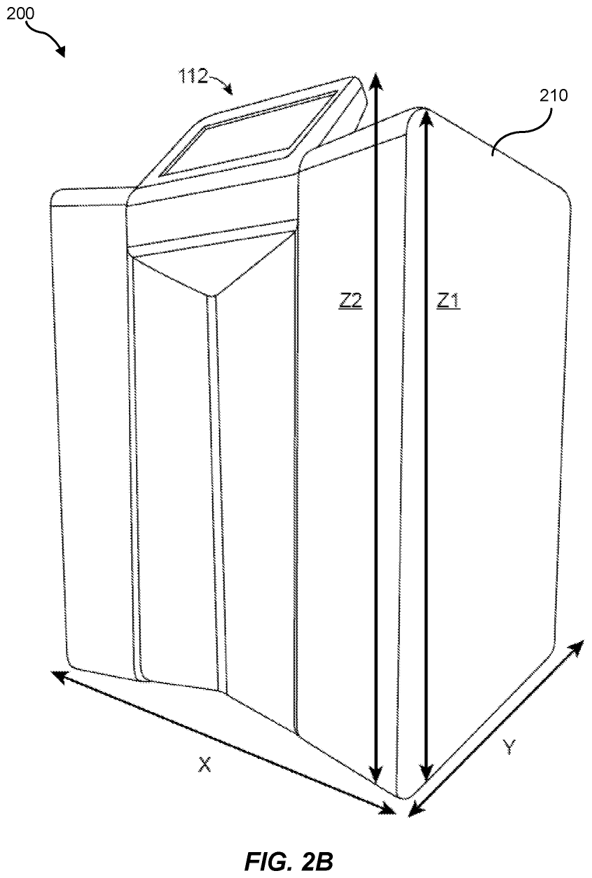

FIG. 2A illustrates a coverslipping system 200 which may be an apparatus for imaging a sample on a microscope slide. Coverslipping system 200 may include microscope 100 and/or portions thereof to view the sample when the microscope slide has been placed on microscope stage 116. Coverslipping system 200 may include a cassette 220 for holding one or more microscope slides 225 and a coverslipping station 230 for preparing slide 225 by adding a coverslip. Coverslipping system 200 may also include a slide loader (e.g., a microscope slide engagement structure 240) that may include one or more linkages (e.g., linkage 250) such as a motor, a gear, an actuator, a belt, etc. The slide loader may be configured to place the microscope slide on microscope stage 116 as will be described further below. Microscope slide engagement structure 240 may be mechanically linked to one or more of cassette 220, coverslipping station 230, and/or microscope stage 116.

Coverslipping system 200 may further include a processor 260 (which in some examples may correspond to controller 106) that may be operatively coupled to microscope 100 and the one or more linkages 250, referred to as linkage 250 herein. For example, processor 260 may be configured to control one or more of cassette 220, coverslipping station 230, microscope stage 116, microscope 100, microscope slide engagement structure 240, and/or linkage 250. Processor 260 may be configured with instructions to perform any of the methods and/or processes described herein. For example, coverslipping system 200 may be configured to perform a method of preparing a microscope slide for imaging a sample (e.g., sample 114) on the microscope slide, the method including placing an oil on the sample, covering the sample with a coverslip, and allowing the oil to spread over the sample between the sample and the coverslip. Coverslipping system 200 may prepare slides in an automated fashion to reduce and/or eliminate a need for manual user intervention, as well as to allow automated scanning of slides.

In some examples, microscope 100, microscope stage 116, the slide loader (e.g., microscope slide engagement structure 240 and/or linkage 250), coverslipping station 230, and cassette 220 may enclosed together within a housing 210. FIG. 2B illustrates coverslipping system 200 within housing 210. User interface 112 may be external to housing 210. In some examples, dimensions of housing 210 may include a width X of approximately 420 mm, a height Z1 of approximately 550 mm (and a height Z2 including user interface 112 of approximately 640 mm), and a length Y of approximately 390 mm, although in other examples housing 210 may have other dimensions as appropriate.

In some examples, a volume of microscope 100, the slide loader, and microscope stage 116 may comprise no more than about 200,000 cubic centimeters (“cc”), in some examples no more than about 100,000 cc, and in some examples no more than 50,000 cc. This volume may include a portion of cassette 220. The portion corresponding to the volume of cassette 220 may be configured to hold a plurality of microscope slides 225. Accordingly, in some examples, housing 210 may enclose a volume of no more than 200,000 cc, no more than 100,000 cc, and/or no more than 50,000 cc.

Linkage 250 may be configured to remove slide 225 from cassette 220, place slide 225 on microscope stage 116, lift slide 225 from microscope stage 116, and place slide 225 in cassette 220. Linkage 250 may include mechanical apparatuses for moving slide 225. For example, linkage 250 may include one or more of a motor, a gear, an actuator, a belt, a conveyor belt, a chain, a threaded member, a bolt, a nut, a pulley, a pull wire, a translation stage, a linear stage, a joint of a robotic arm, a robotic arm, or a gantry. In some examples, linkage 250 may include a single linkage to remove microscope slide 225 from cassette 220, place the transparent flowable material on sample 114, place microscope slide 225 on microscope stage 116, and place microscope slide 225 in cassette 220.

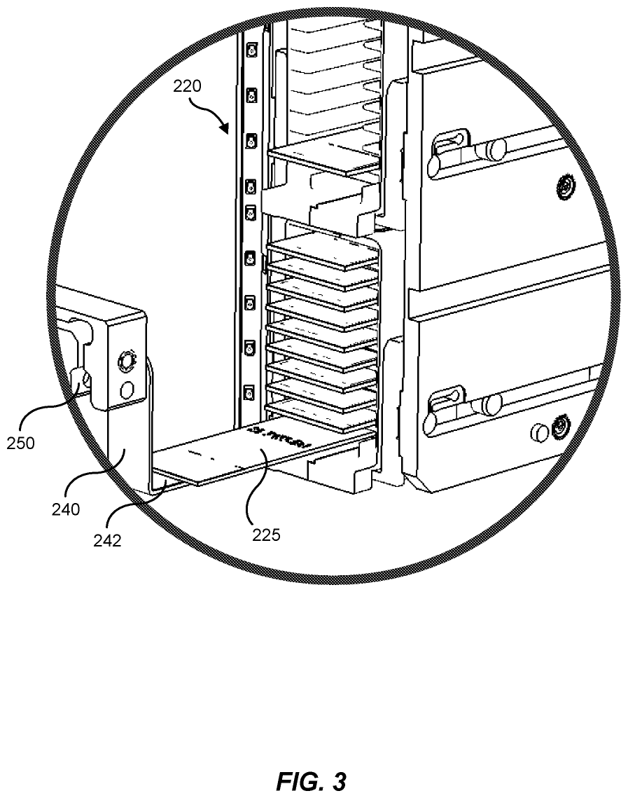

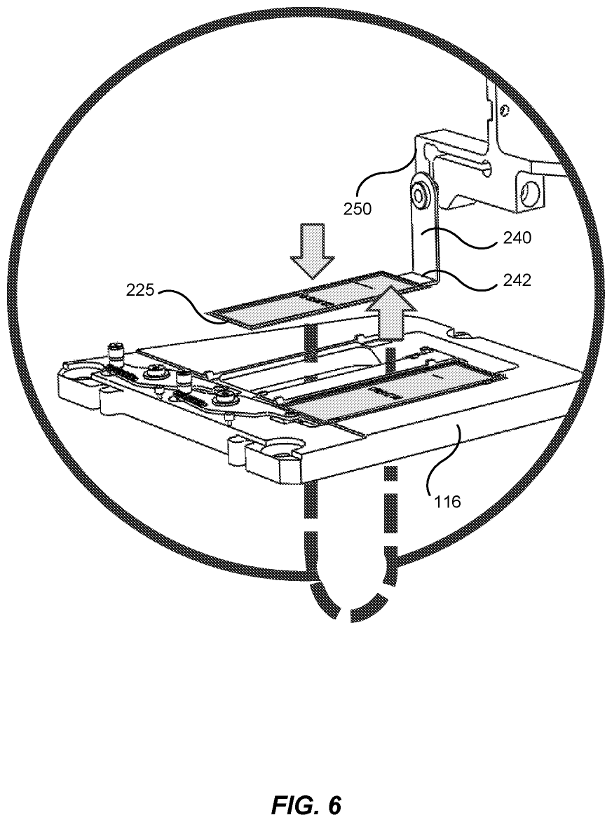

FIG. 3 illustrates linkage 250 removing slide 225 from cassette 220 and/or placing slide 225 into cassette 220. As illustrated in FIG. 3, microscope slide engagement structure 240 may be coupled to the one or more linkages 250. Slide engagement structure 240 may be configured to engage slide 225 and move slide 225 to microscope stage 116 (see, e.g., FIG. 6) and cassette 220 (see, e.g., FIG. 3). In some examples, slide engagement structure 240 may include one or more of an extension (such as an extension 242) sized to fit under slide 225, a slide support to couple to slide 225, a suction source to couple to slide 225, an electronically controlled gripper to hold slide 225, or a mechanical gripper to hold slide 225.

In some examples, the extension sized to fit under slide 225 may include a length greater than a width to fit under slide 225, as shown in FIGS. 3-6. In some examples, extension 242 may include a first laterally extending portion to fit under slide 225, and a second portion extending transverse to the first portion to couple to the one or more linkages 250. In some examples, the second portion may extend one or more of laterally, upwardly or downwardly from the first portion.

In other examples, linkage 250 may include a first linkage coupled to a second linkage. The first linkage may be configured to position microscope slide 225 to place the transparent flowable material on sample 114 and the second linkage may be configured to place slide 225 on microscope stage 116. In some examples, linkage 250 may further include a third linkage to couple the first linkage to the second linkage and transport microscope slide 225 between the first linkage and the second linkage.

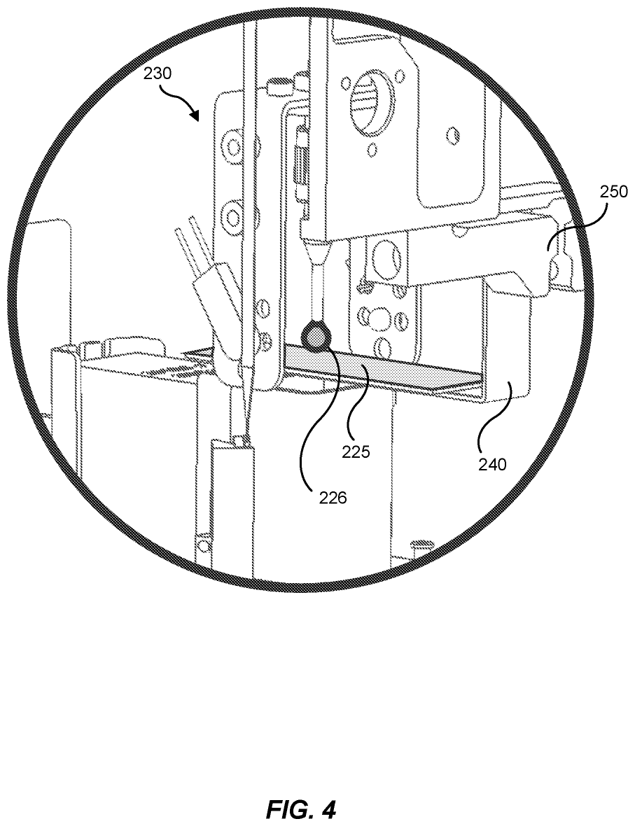

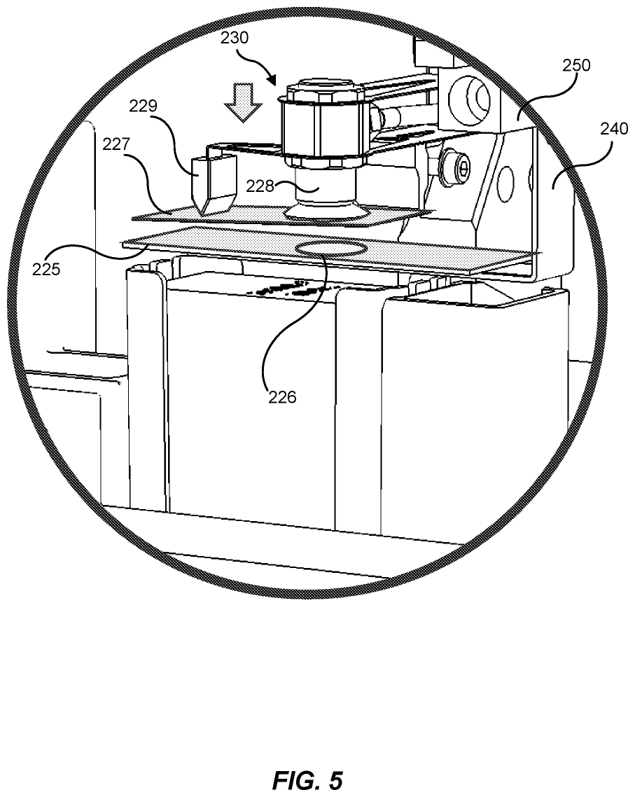

For example, after removing slide 225 from cassette 220, linkage 250 may move slide 225 to coverslipping station 230, as illustrated in FIG. 4. Coverslipping station 230 may place the transparent flowable material 226 on sample 114 (see, e.g., FIG. 4) and place a coverslip 227 on transparent flowable material 226 (see, e.g., FIG. 5).

As illustrated in FIG. 4, coverslipping station 230 may apply transparent flowable material 226 onto slide 225. In some examples, transparent flowable material 226 may be an oil such as an index matching oil comprising an index of refraction within a range from about 1.4 to about 1.6. The use of an oil or other transparent flowable material as the mounting medium rather than a glue may allow less stringent design considerations for applying the mounting medium. For example, coverslipping station 230 may include a channel extending to an opening to place transparent flowable material 226 on sample 114. A gas may be allowed to circulate among microscope 100, microscope stage 116, and the opening to place transparent flowable material 226 on sample 114, the slide loader (e.g., microscope slide engagement structure 240 and/or linkage 250), and cassette 220. In some examples, the gas may comprise air.

In some examples, the channel may extend to the opening to place transparent flowable material 226 on sample 114. In some examples, the channel extending to the opening may include one or more of a nozzle or a needle, as illustrated in FIG. 4.

In some examples, coverslipping system 200 and/or coverslipping station 230 may include a sensor coupled to processor 260. The sensor may detect transparent flowable material 226 released from the needle. The sensor may include one or more of an optical sensor, a photo detector, a photodiode, a light emitting diode (LED), or an infrared (IR) LED. Processor 260 may be configured to move one or more of the opening or the sample to spread transparent flowable material 226 on the sample. For instance, processor 260 may use feedback from the sensor to determine how much transparent flowable material 226 to deposit on the sample.

In some examples, coverslipping station 230 may include a coverslip engagement structure 228 to place a coverslip 227 on transparent flowable material 226. As illustrated in FIG. 5, coverslip engagement structure 228 may hold coverslip 227 until microscope slide engagement structure 240 aligns slide 225 and/or transparent flowable material 226 under coverslip 227. A coverslip disengagement structure 229 may apply a mechanical force (indicated by the arrow in FIG. 5) to place coverslip 227 onto transparent flowable material 226 and slide 225. In such examples, the downward force may be applied to one side of coverslip 227, rather than evenly across coverslip 227, to place coverslip 227 onto transparent flowable material 226 at an angle. Such angled placement of coverslip 227 may improve alignment as well as facilitate spreading and adhesion of transparent flowable material 226. In other examples, other types of coverslip engagement structures may be used to hold and/or place coverslip 227 onto slide 225.

After coverslip 227 is properly placed onto slide 225, microscope slide engagement structure 240 and/or linkage 250 may move slide 225 onto microscope stage 116, as illustrated in FIG. 6. To facilitate swapping of slides, particularly for automated applications, stage 116 may be designed to hold more than one slide.

In some examples, the width of extension 242 may be sized less than a width of microscope slide 225 to allow extension 242 to pass below a support structure of microscope stage 116 and place microscope slide 225 on the support structure.

In some examples, microscope stage 116 may include a first slot and a second slot each sized to receive extension 242 configured to lift microscope slide 225. A channel sized to receive extension 242 may connect the first slot with the second slot to allow extension 242 to move between the first slot and the second slot.

In some examples, microscope stage 116 may include a first support structure to support a first slide positioned on the first slot and a second support structure to support a second slide on the second slot. Extension 242 may be sized to move between the first slot and the second slot to lift the first slide from the first support structure or the second slide from the second support structure.

In some examples, a finger may extend between the first slot and the second slot to define inner portions of the first slot and the second slot, the finger above a lower portion of the channel to allow extension 242 to move in the channel below the finger between the first slot and the second slot. Extension 242 may include a first lateral portion sized to fit under microscope slide 225 and a second transversely extending portion to couple to the one or more linkages 250. The finger may comprise a length sufficiently short to allow the second transversely extending portion of extension 242 to move the lateral portion of extension 242 between the first slot and the second slot, as illustrated in FIG. 6.

More specifically in FIG. 6, extension 242 holding slide 255 may move downwards through the first slot in microscope stage 116. Because the first slot may be smaller than slide 255 yet larger than extension 242, extension 242 may continue moving through and under microscope stage 116 while depositing slide 255 onto microscope stage 116 (e.g., over the first slot). A second slide over the second slot may be picked up by extension 242, which may move laterally from the first slot to the second slot (e.g., in a U-shaped motion as indicated by the dotted line) and up through microscope stage 116. The respective dimensions of the second slot, extension 242, and the second slide may allow extension 242 to move up and through microscope stage 116 and pick up the second slide. Extension 242 may repeat this motion to deposit and pick up slides as needed. In addition, microscope 100 may be configured to move image capture device 102 and/or microscope stage 116 to capture a desired slide on microscope stage 116.

Accordingly, as further described herein, coverslipping system 200 may be configured to retrieve slide 225 from cassette 220 (e.g., using at least linkage 250), and at coverslipping station 230 (which may include or accept microscope slide engagement structure 240), place transparent flowable material 226 onto sample 114 and/or slide 225, and place coverslip 227 onto transparent flowable material 226 to complete a coverslipping process for slide 225. Coverslipping system 200 may further be configured to move (e.g., using at least linkage 250 which the same or a different linkage 250 than what was used to retrieve slide 225 from cassette 220, further supported in some examples by microscope slide engagement structure 240 which may also be the same or a different microscope slide engagement structure 240 than what was used with coverslipping station 230) slide 225 from coverslipping station 230 to microscope stage 116 (which may also include and/or accept microscope slide engagement structure 240) such that microscope 100 may scan slide 225. After scanning slide 225, coverslipping system 200 may move (using at least linkage 250, which may also include a previously-used or a different microscope engagement structure 240) slide 225 back into cassette 220 (e.g., at the same location or at a different location as needed to track which slides have been scanned). Coverslipping system 200 may be configured to perform one or more of these steps in an automated fashion requiring little to no user intervention once the process starts.

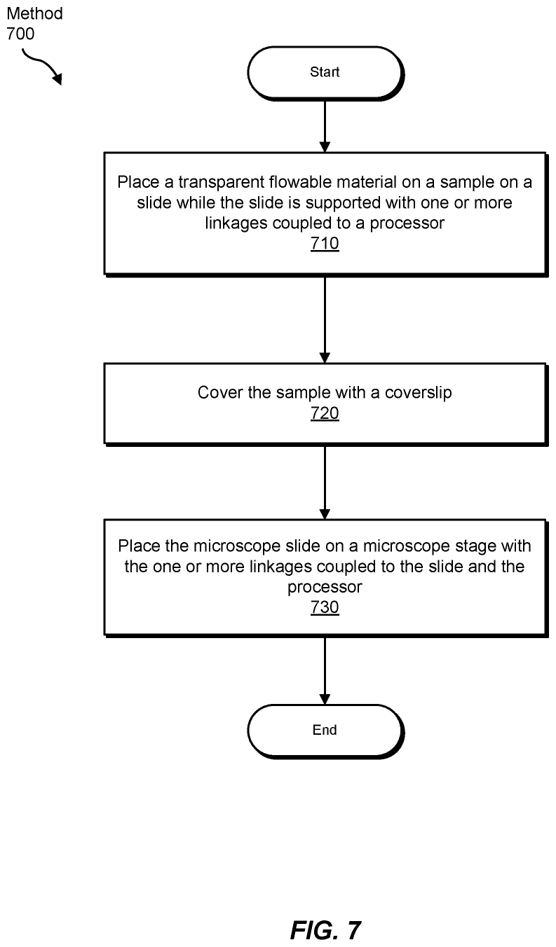

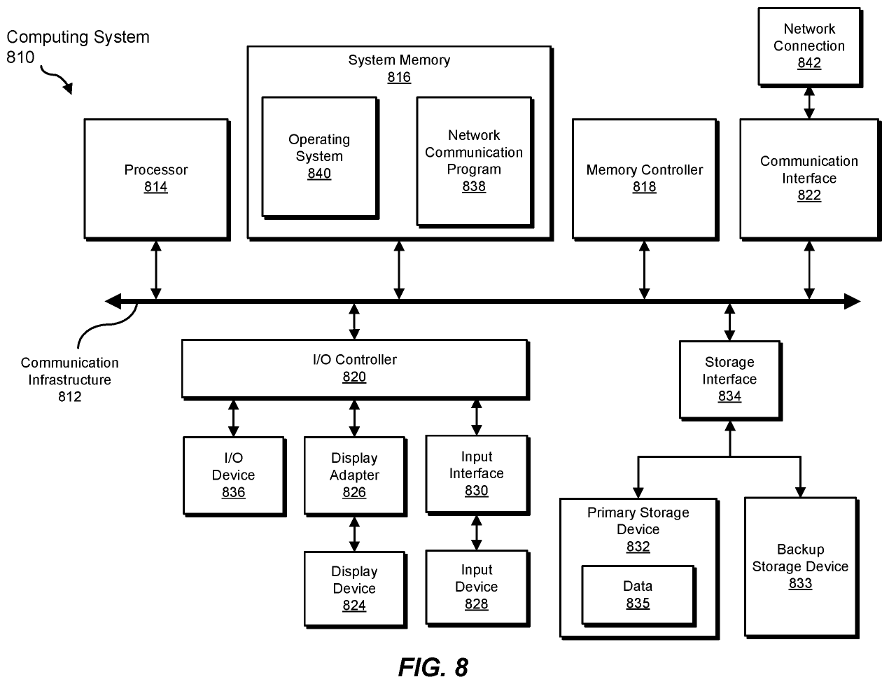

FIG. 7 is a flow diagram of an exemplary computer-implemented method 700 for preparing a microscope slide for imaging a sample on the microscope slide. The steps shown in FIG. 7 may be performed by a microscope system with an integrated coverslipping device, such as the system(s) illustrated in FIGS. 1, 8, and/or 9. In one example, each of the steps shown in FIG. 7 may represent an algorithm whose structure includes and/or is represented by multiple sub-steps, examples of which will be provided in greater detail below.

As illustrated in FIG. 7, at step 710 one or more of the systems described herein may place a transparent flowable material on the sample while the slide is supported with one or more linkages coupled to a processor. For example, coverslipping station 230 may place transparent flowable material 226 on sample 114 while slide 225 is supported with linkage 250 coupled to processor 260. In other examples, coverslipping station 230 may include a support for holding slide 225 (e.g., after being placed thereupon by linkage 250) for placing transparent flowable material 226 on sample 114. Microscope slide engagement structure 240 may be integrated with coverslipping station 230 (e.g., separate from linkage 250) and/or may be connected with linkage 250.

In some examples, the transparent flowable material may comprise an oil. For instance, the transparent flowable material may have a viscosity within a range from about 10 centipoise (“cP”) to about 2000 cP, optionally from 100 cP to about 2000 cP, optionally from 100 cP to 1000 cP, and optionally from 100 cP to 300 cP. In some examples, the transparent flowable material may have a boiling point greater than 250° C. at standard atmospheric pressure (101.3 kPa). In some examples, the transparent flowable material may have a thickness within a range from 5 micrometers (μm) microns to 80 μm between the sample and the coverslip when removed from the microscope stage, and optionally within a range from 10 μm to 20 μm. In some examples, the flowable material may have a viscous material having the thickness when the sample is imaged with a microscope.

In some examples, the transparent flowable material may not comprise a volatile organic compound (VOC). In some examples, the transparent flowable material may not comprise an adhesive. In other examples, the transparent flowable material may comprise an adhesive.

In some examples, the microscope slide (e.g., microscope slide 225) may be placed on the microscope stage (e.g., microscope stage 116) with a slide engagement structure (e.g., microscope slide engagement structure 240) coupled to the linkage (e.g., linkage 250) and the flowable material (e.g., transparent flowable material 226) is placed on the sample (e.g., sample 114) while the microscope slide is supported with the slide engagement structure.

In some examples, the transparent flowable material may be placed on the sample with a channel extending to an opening. The channel extending to the opening may include one or more of a needle or a nozzle (see, e.g., FIG. 4). In some examples, the transparent flowable material may be sprayed on the sample. In some examples, a gap may extend between the sample and the opening to place the transparent flowable material on the sample. The gap may be sized to form a drop near the opening and to contact the sample while the drop is supported near the opening (see, e.g., FIG. 4). Alternatively, the gap may be sized to contact the sample with the drop before the drop falls from the opening. The drop may have a volume of no more than 16 micro liters (“μL”) in some examples. In yet other examples, the gap may be sized to contact the sample with the drop after the drop falls from the opening. In other examples, the one or more of the needle or the nozzle may contact the sample to place the transparent flowable material on the sample without a gap between the sample and the opening. In some examples, an amount of transparent flowable material placed on the sample may be within a range from about 10 microliters (μL) to about 60 μL, and optionally within a range from about 10 μL to 16 μL, 16 μL to 25 μL, 25 μL to 35 μL, or 35 μL to 60 μL.

In some examples, the flowable material may be placed on the sample before the coverslip is placed on the flowable material and the flowable material may be allowed to spread while the microscope slide is coupled to the linkage. For instance, the transparent flowable material may be allowed to spread on the sample before imaging the sample. More specifically, the flowable material may be allowed to spread over the sample for a time within a range from about 5 seconds to about 120 seconds, and optionally from about 10 seconds to about 60 seconds.

At step 720 one or more of the systems described herein may cover the sample with a coverslip. For example, coverslipping station 230 may cover sample 114 (and transparent flowable material 226) with coverslip 227.

In some examples, the coverslip (e.g., coverslip 227) may be placed on the flowable material (e.g., transparent flowable material 226) while the microscope slide (e.g., microscope slide 225) is supported with the slide engagement structure (e.g., microscope slide engagement structure 240).

In some examples, a pair of extensions may engage the coverslip from opposite sides to move the coverslip into alignment with the microscope slide while the microscope slide is coupled to the linkage. Optionally, the pair of extensions may align the slide with one or more of the slide engagement structure or the microscope stage.

In some examples, the flowable material may be allowed to spread over the sample for the time within the range after placing the coverslip on the flowable material. For instance, the time within the range may include a first time before the coverslip is placed on the flowable material and a second time after the coverslip is placed on the flowable material.

In some examples, the coverslip may be placed over the sample after placing a final amount of the flowable material on the sample. For example, the coverslip may be placed within about 0.5 seconds to about 30 seconds after placing the final amount on the sample, and optionally within about 1 second to about 10 seconds.

At step 730 one or more of the systems described herein may place the microscope slide on a microscope stage with the one or more linkages coupled to the slide and the processor. For example, microscope slide engagement structure 240 may place slide 225 on microscope stage 116 with linkage 250 coupled to slide 225 and processor 260. In other examples, linkage 250 may pick up slide 225 from microscope slide engagement structure 240 (e.g., from coverslipping station 230) and place slide 225 onto microscope stage 116.

In some examples, the one or more linkages (e.g., linkage 250) may be coupled to a slide engagement structure (e.g., microscope slide engagement structure 240) configured to engage the microscope slide (e.g., slide 225) and move the microscope slide to the microscope stage (e.g., microscope stage 116) with the one or more linkages. The slide engagement structure may include one or more of an extension sized to fit under the slide, a slide support to couple to the slide, a suction source to couple to the slide, an electronically controlled gripper to hold the slide or a mechanical gripper to hold the slide.

In some examples (e.g., see FIG. 6), the microscope slide may be placed on the microscope stage at a first location of the microscope stage and a second slide that has been previously placed at a second location of the microscope stage is lifted from the microscope stage and placed in a cassette (e.g., cassette 220). For example, the microscope slide may be placed on the microscope stage at the first location with an extension beneath the microscope slide. There may be a relative lateral movement between the extension, the first slot and the second slot with the extension beneath the microscope slide. Further, the extension may be moved laterally from a first position beneath the microscope slide to a second position beneath the second microscope slide prior to lifting the second slide from the microscope stage. For instance, the microscope stage may be moved laterally from a first position to a second position prior to lifting the second slide from the microscope stage. In other examples, both the extension and the microscope stage may be moved as needed for the relative lateral movement.

In some examples, the steps of placing the transparent flowable material, covering the sample, and placing the microscope slide on the microscope stage are performed automatically in response to a user input to scan a plurality of slides in a cassette with a microscope. For instance, a user may use user interface 112 to initiate scanning of multiple slides in cassette 220, which may include coverslipping each slide before scanning.

In some examples, the steps of placing the transparent flowable material, covering the sample, and placing the microscope slide on the microscope stage may be performed within a housing (e.g., housing 210) enclosing the slide with the sample and the microscope stage. In some examples, the slide may be placed on an intermediate support after the transparent flowable material has been placed on the sample and before the microscope slide has been placed on the microscope stage.

The present disclosure provides various improvements to coverslipping techniques. As described herein, the systems and methods provided may use oil (or another transparent flowable material) as the mounting medium and integrate a coverslipping device with a slide scanner. Using oil rather than glue as the mounting medium may allow for faster coverslipping, which may be particularly significant for high-throughput slide scanners. Many types of oil having equivalent optical properties as that of glues used for mounting mediums are available and suitable for microscopic imaging. Such suitable oils may be non-toxic and much easier to clean from the sample than glues. In cases where a secondary staining procedure is desired or if there was a problem with the initial process, the ease of cleaning the oil from the sample may be highly desirable.

The oil used for coverslipping may typically have a viscosity of about 150 cp or higher (in some examples the viscosity may be as high as 50,000 cp or more), although in other examples lower viscosity may also be used. Common oils may be between 100-2000 cp for good results in terms of avoiding air bubbles and limiting spreading time for the oil.

The process of coverslipping with oil may include delivering in some way an amount of oil onto the microscope slide (by dropping the oil, using a “wand,” etc.) and then putting the coverslip on top of the oil. The coverslip may be laid down diagonally on the oil or in a gradual angle, which may improve spreading. In other examples, coverslip placement may be performed by first putting the oil on the coverslip and then the slide on the oil.

A coverslipping device that is integrated with a slide scanner device may provide a more efficient workflow because the slides have to be inserted only once, directly to the slide scanner, rather than inserted and removed multiple times between different devices. In addition the integrated device may be more compact than a series of several independent devices.

Because coverslipping with oil may be faster than using glue, the coverslipping techniques described herein may be more suitable for an integrated coverslipping-whole slide scanner device. A high throughput is often an important desired property of such a device, and the coverslipping techniques described herein may support the high throughput. In some examples, using glue in a coverslipper that is integrated with a slide scanner may be relevant and covered by this disclosure.

FIG. 8 is a block diagram of an example computing system 810 capable of implementing one or more of the embodiments described and/or illustrated herein. For example, all or a portion of computing system 810 may perform and/or be a means for performing, either alone or in combination with other elements, one or more of the steps described herein (such as one or more of the steps illustrated in FIG. 7). All or a portion of computing system 810 may also perform and/or be a means for performing any other steps, methods, or processes described and/or illustrated herein. All or a portion of computing system 810 may correspond to or otherwise be integrated with microscope 100 (e.g., one or more of controller 106, memory 108, and/or user interface 112).

Computing system 810 broadly represents any single or multi-processor computing device or system capable of executing computer-readable instructions. Examples of computing system 810 include, without limitation, workstations, laptops, client-side terminals, servers, distributed computing systems, handheld devices, or any other computing system or device. In its most basic configuration, computing system 810 may include at least one processor 814 and a system memory 816.

Processor 814 generally represents any type or form of physical processing unit (e.g., a hardware-implemented central processing unit) capable of processing data or interpreting and executing instructions. In certain embodiments, processor 814 may receive instructions from a software application or module. These instructions may cause processor 814 to perform the functions of one or more of the example embodiments described and/or illustrated herein.

System memory 816 generally represents any type or form of volatile or non-volatile storage device or medium capable of storing data and/or other computer-readable instructions. Examples of system memory 816 include, without limitation, Random Access Memory (RAM), Read Only Memory (ROM), flash memory, or any other suitable memory device. Although not required, in certain embodiments computing system 810 may include both a volatile memory unit (such as, for example, system memory 816) and a non-volatile storage device (such as, for example, primary storage device 832, as described in detail below). In one example, one or more of steps from FIG. 7 may be computer instructions that may be loaded into system memory 816.

In some examples, system memory 816 may store and/or load an operating system 840 for execution by processor 814. In one example, operating system 840 may include and/or represent software that manages computer hardware and software resources and/or provides common services to computer programs and/or applications on computing system 810. Examples of operating system 840 include, without limitation, LINUX, JUNOS, MICROSOFT WINDOWS, WINDOWS MOBILE, MAC OS, APPLE'S IOS, UNIX, GOOGLE CHROME OS, GOOGLE'S ANDROID, SOLARIS, variations of one or more of the same, and/or any other suitable operating system.

In certain embodiments, example computing system 810 may also include one or more components or elements in addition to processor 814 and system memory 816. For example, as illustrated in FIG. 8, computing system 810 may include a memory controller 818, an Input/Output (I/O) controller 820, and a communication interface 822, each of which may be interconnected via a communication infrastructure 812. Communication infrastructure 812 generally represents any type or form of infrastructure capable of facilitating communication between one or more components of a computing device. Examples of communication infrastructure 812 include, without limitation, a communication bus (such as an Industry Standard Architecture (ISA), Peripheral Component Interconnect (PCI), PCI Express (PCIe), or similar bus) and a network.

Memory controller 818 generally represents any type or form of device capable of handling memory or data or controlling communication between one or more components of computing system 810. For example, in certain embodiments memory controller 818 may control communication between processor 814, system memory 816, and I/O controller 820 via communication infrastructure 812.

I/O controller 820 generally represents any type or form of module capable of coordinating and/or controlling the input and output functions of a computing device. For example, in certain embodiments I/O controller 820 may control or facilitate transfer of data between one or more elements of computing system 810, such as processor 814, system memory 816, communication interface 822, display adapter 826, input interface 830, and storage interface 834.

As illustrated in FIG. 8, computing system 810 may also include at least one display device 824 (which may correspond to user interface 112) coupled to I/O controller 820 via a display adapter 826. Display device 824 generally represents any type or form of device capable of visually displaying information forwarded by display adapter 826. Similarly, display adapter 826 generally represents any type or form of device configured to forward graphics, text, and other data from communication infrastructure 812 (or from a frame buffer, as known in the art) for display on display device 824.

As illustrated in FIG. 8, example computing system 810 may also include at least one input device 828 (which may correspond to user interface 112) coupled to I/O controller 820 via an input interface 830. Input device 828 generally represents any type or form of input device capable of providing input, either computer or human generated, to example computing system 810. Examples of input device 828 include, without limitation, a keyboard, a pointing device, a speech recognition device, variations or combinations of one or more of the same, and/or any other input device.

Additionally or alternatively, example computing system 810 may include additional I/O devices. For example, example computing system 810 may include I/O device 836. In this example, I/O device 836 may include and/or represent a user interface that facilitates human interaction with computing system 810. Examples of I/O device 836 include, without limitation, a computer mouse, a keyboard, a monitor, a printer, a modem, a camera, a scanner, a microphone, a touchscreen device, variations or combinations of one or more of the same, and/or any other I/O device.

Communication interface 822 broadly represents any type or form of communication device or adapter capable of facilitating communication between example computing system 810 and one or more additional devices. For example, in certain embodiments communication interface 822 may facilitate communication between computing system 810 and a private or public network including additional computing systems. Examples of communication interface 822 include, without limitation, a wired network interface (such as a network interface card), a wireless network interface (such as a wireless network interface card), a modem, and any other suitable interface. In at least one embodiment, communication interface 822 may provide a direct connection to a remote server via a direct link to a network, such as the Internet. Communication interface 822 may also indirectly provide such a connection through, for example, a local area network (such as an Ethernet network), a personal area network, a telephone or cable network, a cellular telephone connection, a satellite data connection, or any other suitable connection.

In certain embodiments, communication interface 822 may also represent a host adapter configured to facilitate communication between computing system 810 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 822 may also allow computing system 810 to engage in distributed or remote computing. For example, communication interface 822 may receive instructions from a remote device or send instructions to a remote device for execution.

In some examples, system memory 816 may store and/or load a network communication program 838 for execution by processor 814. In one example, network communication program 838 may include and/or represent software that enables computing system 810 to establish a network connection 842 with another computing system (not illustrated in FIG. 8) and/or communicate with the other computing system by way of communication interface 822. In this example, network communication program 838 may direct the flow of outgoing traffic that is sent to the other computing system via network connection 842. Additionally or alternatively, network communication program 838 may direct the processing of incoming traffic that is received from the other computing system via network connection 842 in connection with processor 814.

Although not illustrated in this way in FIG. 8, network communication program 838 may alternatively be stored and/or loaded in communication interface 822. For example, network communication program 838 may include and/or represent at least a portion of software and/or firmware that is executed by a processor and/or Application Specific Integrated Circuit (ASIC) incorporated in communication interface 822.

As illustrated in FIG. 8, example computing system 810 may also include a primary storage device 832 and a backup storage device 833 coupled to communication infrastructure 812 via a storage interface 834. Storage devices 832 and 833 generally represent any type or form of storage device or medium capable of storing data and/or other computer-readable instructions. For example, storage devices 832 and 833 may be a magnetic disk drive (e.g., a so-called hard drive), a solid state drive, a floppy disk drive, a magnetic tape drive, an optical disk drive, a flash drive, or the like. Storage interface 834 generally represents any type or form of interface or device for transferring data between storage devices 832 and 833 and other components of computing system 810. In one example, data 835 (which may correspond to the captured images described herein) may be stored and/or loaded in primary storage device 832.

In certain embodiments, storage devices 832 and 833 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 832 and 833 may also include other similar structures or devices for allowing computer software, data, or other computer-readable instructions to be loaded into computing system 810. For example, storage devices 832 and 833 may be configured to read and write software, data, or other computer-readable information. Storage devices 832 and 833 may also be a part of computing system 810 or may be a separate device accessed through other interface systems.

Many other devices or subsystems may be connected to computing system 810. Conversely, all of the components and devices illustrated in FIG. 8 need not be present to practice the embodiments described and/or illustrated herein. The devices and subsystems referenced above may also be interconnected in different ways from that shown in FIG. 8. Computing system 810 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 810. All or a portion of the computer program stored on the computer-readable medium may then be stored in system memory 816 and/or various portions of storage devices 832 and 833. When executed by processor 814, a computer program loaded into computing system 810 may cause processor 814 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 810 may be configured as an Application Specific Integrated Circuit (ASIC) adapted to implement one or more of the example embodiments disclosed herein.

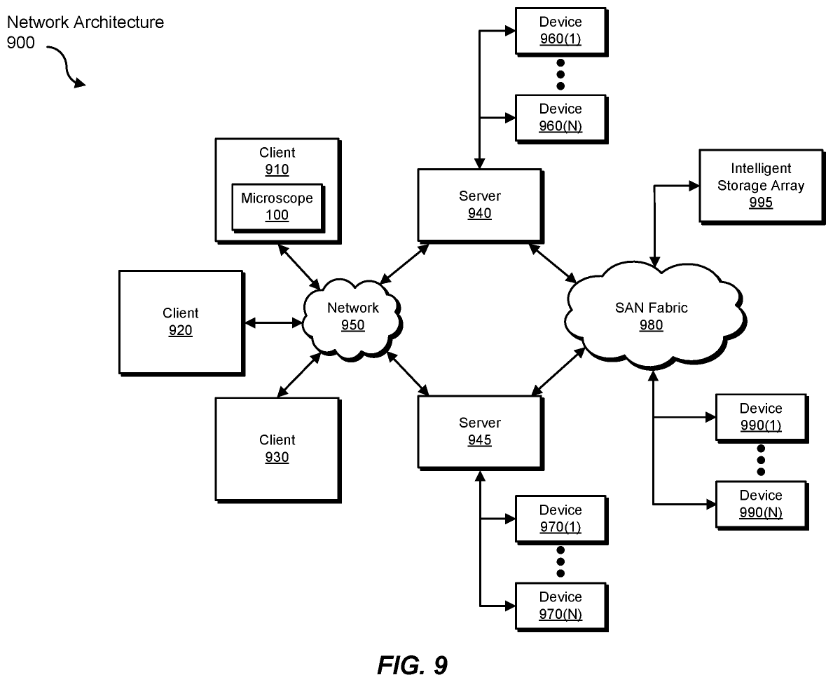

FIG. 9 is a block diagram of an example network architecture 900 in which client systems 910, 920, and 930 and servers 940 and 945 may be coupled to a network 950. As detailed above, all or a portion of network architecture 900 may perform and/or be a means for performing, either alone or in combination with other elements, one or more of the steps disclosed herein (such as one or more of the steps illustrated in FIG. 7). All or a portion of network architecture 900 may also be used to perform and/or be a means for performing other steps and features set forth in the instant disclosure.

Client systems 910, 920, and 930 generally represent any type or form of computing device or system, such as example computing system 810 in FIG. 8. Similarly, servers 940 and 945 generally represent computing devices or systems, such as application servers or database servers, configured to provide various database services and/or run certain software applications. Network 950 generally represents any telecommunication or computer network including, for example, an intranet, a WAN, a LAN, a PAN, or the Internet. In one example, client systems 910, 920, and/or 930 and/or servers 940 and/or 945 may include all or a portion of microscope 100 from FIG. 1.

As illustrated in FIG. 9, one or more storage devices 960(1)-(N) may be directly attached to server 940. Similarly, one or more storage devices 970(1)-(N) may be directly attached to server 945. Storage devices 960(1)-(N) and storage devices 970(1)-(N) generally represent any type or form of storage device or medium capable of storing data and/or other computer-readable instructions. In certain embodiments, storage devices 960(1)-(N) and storage devices 970(1)-(N) may represent Network-Attached Storage (NAS) devices configured to communicate with servers 940 and 945 using various protocols, such as Network File System (NFS), Server Message Block (SMB), or Common Internet File System (CIFS).

Servers 940 and 945 may also be connected to a Storage Area Network (SAN) fabric 980. SAN fabric 980 generally represents any type or form of computer network or architecture capable of facilitating communication between a plurality of storage devices. SAN fabric 980 may facilitate communication between servers 940 and 945 and a plurality of storage devices 990(1)-(N) and/or an intelligent storage array 995. SAN fabric 980 may also facilitate, via network 950 and servers 940 and 945, communication between client systems 910, 920, and 930 and storage devices 990(1)-(N) and/or intelligent storage array 995 in such a manner that devices 990(1)-(N) and array 995 appear as locally attached devices to client systems 910, 920, and 930. As with storage devices 960(1)-(N) and storage devices 970(1)-(N), storage devices 990(1)-(N) and intelligent storage array 995 generally represent any type or form of storage device or medium capable of storing data and/or other computer-readable instructions.

In certain embodiments, and with reference to example computing system 810 of FIG. 8, a communication interface, such as communication interface 822 in FIG. 8, may be used to provide connectivity between each client system 910, 920, and 930 and network 950. Client systems 910, 920, and 930 may be able to access information on server 940 or 945 using, for example, a web browser or other client software. Such software may allow client systems 910, 920, and 930 to access data hosted by server 940, server 945, storage devices 960(1)-(N), storage devices 970(1)-(N), storage devices 990(1)-(N), or intelligent storage array 995. Although FIG. 9 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 940, server 945, storage devices 960(1)-(N), storage devices 970(1)-(N), storage devices 990(1)-(N), intelligent storage array 995, or any combination thereof. All or a portion of one or more of the example embodiments disclosed herein may also be encoded as a computer program, stored in server 940, run by server 945, and distributed to client systems 910, 920, and 930 over network 950.

As detailed above, computing system 810 and/or one or more components of network architecture 900 may perform and/or be a means for performing, either alone or in combination with other elements, one or more steps of an example method for coverslipping. This coverslipping may be used for various types of analysis, including but not limited to peripheral blood smear analysis, bone marrow aspirate analysis, etc.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor. The processor may comprise a distributed processor system, e.g. running parallel processors, or a remote processor such as a server, and combinations thereof.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

It will be understood that although the terms “first,” “second,” “third”, etc. may be used herein to describe various layers, elements, components, regions or sections without referring to any particular order or sequence of events. These terms are merely used to distinguish one layer, element, component, region or section from another layer, element, component, region or section. A first layer, element, component, region or section as described herein could be referred to as a second layer, element, component, region or section without departing from the teachings of the present disclosure.

As used herein, the term “or” is used inclusively to refer items in the alternative and in combination.

As used herein, characters such as numerals refer to like elements.

As used herein, the terms “comprise” and “include” are interchangeable.

As used herein, the terms “in response to” and “based on” are interchangeable.

The present disclosure includes the following numbered clauses.
Clause 1. A method of preparing a microscope slide for imaging a sample on the microscope slide, the method comprising: placing a transparent flowable material on the sample while the slide is supported with one or more linkages coupled to a processor; covering the sample with a coverslip; and placing the microscope slide on a microscope stage with the one or more linkages coupled to the slide and the processor.
Clause 2. The method of clause 1, wherein the one or more linkages is coupled to a slide engagement structure configured to engage the microscope slide and move the microscope slide to the microscope stage with the one or more linkages, the slide engagement structure comprising one or more of an extension sized to fit under the slide, a slide support to couple to the slide, a suction source to couple to the slide, an electronically controlled gripper to hold the slide or a mechanical gripper to hold the slide.
Clause 3. The method of clause 1, wherein the microscope slide is placed on the microscope stage with a slide engagement structure coupled to the linkage and the flowable material is placed on the sample while the microscope slide is supported with the slide engagement structure.
Clause 4. The method of clause 3, wherein the coverslip is placed on the flowable material while the microscope slide is supported with the slide engagement structure.
Clause 5. The method of clause 1, wherein a pair of extensions engages the coverslip from opposite sides to move the coverslip into alignment with the microscope slide while the microscope slide is coupled to the linkage and optionally wherein the pair of extensions aligns the slide with one or more of the slide engagement structure or the microscope stage.
Clause 6. The method of clause 1, wherein the microscope slide is placed on the microscope stage at a first location of the microscope stage and a second slide that has been previously placed at a second location of the microscope stage is lifted from the microscope stage and placed in a cassette.
Clause 7. The method of clause 6, wherein the microscope slide is placed on the microscope stage at the first location with an extension beneath the microscope slide.
Clause 8. The method of clause 7, wherein there is relative lateral movement between the extension, the first slot and the second slot with the extension beneath the microscope slide.
Clause 9. The method of clause 7, wherein the extension is moved laterally from a first position beneath the microscope slide to a second position beneath the second microscope slide prior to lifting the second slide from the microscope stage.
Clause 10. The method of clause 7, wherein the microscope stage is moved laterally from a first position to a second position prior to lifting the second slide from the microscope stage.
Clause 11. The method of clause 1, wherein the flowable material is placed on the sample before the coverslip is placed on the flowable material and the flowable material is allowed to spread while the microscope slide is coupled to the linkage.
Clause 12. The method of clause 1, wherein the transparent flowable material is allowed to spread on the sample before imaging the sample.
Clause 13. The method of clause 12, wherein the flowable material is allowed to spread over the sample for a time within a range from about 5 seconds to about 120 seconds and optionally from about 10 seconds to about 60 seconds.
Clause 14. The method of clause 13, wherein the flowable material is allowed to spread over the sample for the time within the range after placing the coverslip on the flowable material.
Clause 15. The method of clause 13, wherein the time within the range comprises a first time before the coverslip is placed on the flowable material and a second time after the coverslip is placed on the flowable material.
Clause 16. The method of clause 1, wherein the coverslip is placed over the sample after placing a final amount of the flowable material on the sample.
Clause 17. The method of clause 16, wherein the coverslip is placed within about 0.5 seconds to about 30 seconds after placing the final amount on the sample and optionally within about 1 second to about 10 seconds.
Clause 18. The method of clause 1, wherein the transparent flowable material is placed on the sample with a channel extending to an opening and optionally wherein the channel extending to the opening comprises one or more of a needle or a nozzle.
Clause 19. The method of clause 18, wherein the transparent flowable material is sprayed on the sample.
Clause 20. The method of clause 18, wherein a gap extends between the sample and the opening to place the transparent flowable material on the sample.
Clause 21. The method of clause 18, wherein the gap is sized to form a drop near the opening and to contact the sample while the drop is supported near the opening.
Clause 22. The method of clause 21, wherein the gap is sized to contact the sample with the drop before the drop falls from the opening.
Clause 23. The method of clause 21, wherein the drop comprises a volume of no more than 16 micro liters (“μL”).
Clause 24. The method of clause 20, wherein the gap is sized to contact the sample with the drop after the drop falls from the opening.
Clause 25. The method of clause 18, wherein the one or more of the needle or the nozzle contacts the sample places the transparent flowable material on the sample without a gap between the sample and the opening.
Clause 26. The method of clause 18, wherein an amount of transparent flowable material placed on the sample is within a range from about 10 microliters (IL) to about 60 μL and optionally within a range from about 10 μL to 16 μL, 16 μL to 25 μL, 25 μL to 35 μL, or 35 μL to 60 μL.
Clause 27. The method of clause 1, wherein the transparent flowable material comprises a viscosity within a range from about 10 centipoise (“cP”) to about 2000 cP, optionally from 100 cP to about 2000 cP, optionally from 100 cP to 1000 cP and optionally from 100 cP to 300 cP.
Clause 28. The method of clause 1, wherein the transparent flowable material comprises an oil.
Clause 29. The method of clause 1, wherein the transparent flowable material comprises a boiling point greater than 250° C. at standard atmospheric pressure (101.3 kPa).
Clause 30. The method of clause 29, wherein the transparent flowable material does not comprise a volatile organic compound (VOC).
Clause 31. The method of clause 1, wherein the transparent flowable material does not comprise an adhesive.
Clause 32. The method of clause 1, wherein the transparent flowable material comprises an adhesive.
Clause 33. The method of clause 1, wherein the transparent flowable material comprises a thickness within a range from 5 micrometers (μm) microns to 80 μm between the sample and the coverslip when removed from the microscope stage and optionally within a range from 10 μm to 20 μm.
Clause 34. The method of clause 33, wherein the flowable material comprises a viscous material having the thickness when the sample is imaged with a microscope.
Clause 35. The method of clause 1, wherein the steps of placing the transparent flowable material, covering the sample, and placing the microscope slide on the microscope stage are performed automatically in response to a user input to scan a plurality of slides in a cassette with a microscope.
Clause 36. The method of clause 1, wherein the slide is placed on an intermediate support after the transparent flowable material has been placed on the sample and before the microscope slide has been placed on the microscope stage.
Clause 37. The method of clause 1, wherein the steps of placing the transparent flowable material, covering the sample, and placing the microscope slide on the microscope stage are performed within a housing enclosing the slide with the sample and the microscope stage.
Clause 38. A method of preparing a microscope slide for imaging a sample on the microscope slide, the method comprising: placing an oil on the sample; covering the sample with a coverslip; and allowing the oil to spread over the sample between the sample and the coverslip.
Clause 39. An apparatus for imaging a sample on a microscope slide, the apparatus comprising: a microscope to view the sample when the microscope slide has been placed on a microscope stage; a slide loader comprising one or more linkages, the slide loader configured to place the microscope slide on a microscope stage; a processor operatively coupled to the microscope and the one or more linkages, the processor configured with instructions to perform the method of any one of the preceding clauses.
Clause 40. The apparatus of clause 39, wherein the one or more linkages is configured to remove the microscope slide from a cassette, place the microscope slide on the microscope stage, lift the microscope slide from the microscope stage and place the microscope slide in the cassette.
Clause 41. The apparatus of clause 40, further comprising a slide engagement structure coupled to the one or more linkages, the slide engagement structure configured to engage the slide and move the slide to the microscope stage and a cassette and optionally wherein the slide engagement structure comprises one or more of an extension sized to fit under the slide, a slide support to couple to the slide, a suction source to couple to the slide, an electronically controlled gripper to hold the slide, or a mechanical gripper to hold the slide.
Clause 42. The apparatus of clause 41, wherein the extension sized to fit under the slide comprises a length greater than a width to fit under the microscope slide.
Clause 43. The apparatus of clause 42, wherein the extension comprises a first laterally extending portion to fit under the slide, and a second portion extending transverse to the first portion to couple to the one or more linkages, and optionally wherein the second portion extends one or more of laterally, upwardly or downwardly from the first portion.
Clause 44. The apparatus of clause 43, wherein the width is sized less than a width of the microscope slide to allow the extension to pass below a support structure of the microscope stage and place the microscope slide on the support structure.
Clause 45. The apparatus of clause 39, wherein the microscope stage comprises a first slot and a second slot each sized to receive an extension configured to lift the microscope slide and wherein a channel sized to receive the extension connects the first slot with the second slot to allow the extension to move between the first slot and the second slot.
Clause 46. The apparatus of clause 45, wherein the microscope stage comprises a first support structure to support a first slide positioned on the first slot and a second support structure to support a second slide on the second slot, the extension sized to move between the first slot and the second slot to lift the first slide from the first support structure or the second slide from the second support structure.
Clause 47. The apparatus of clause 45, wherein a finger extends between the first slot and the second slot to define inner portions of the first slot and the second slot, the finger above a lower portion of the channel to allow the extension to move in the channel below the finger between the first slot and the second slot.
Clause 48. The apparatus of clause 47, wherein the extension comprises a first lateral portion sized to fit under the microscope slide and a second transversely extending portion to couple to the one or more linkages and wherein the finger comprises a length sufficiently short to allow the second transversely extending portion of the extension to move the lateral portion of the extension between the first slot and the second slot.
Clause 49. The apparatus of clause 39, further comprising a channel extending to an opening to place the flowable material on the sample and optionally wherein the channel extending to the opening comprises one or more of a nozzle or a needle.
Clause 50. The apparatus of clause 49, further comprising a sensor to detect flowable material released from the needle and optionally wherein the sensor comprises one or more of an optical sensor, a photo detector, a photodiode, a light emitting diode (LED), or an infrared (IR) LED.
Clause 51. The apparatus of clause 49, wherein the processor is configured to move one or more of the opening or the sample to spread the flowable material on the sample.
Clause 52. The apparatus of clause 39, wherein a volume of the microscope, the slide loader and the microscope stage comprise no more than about 200,000 cubic centimeters (“cc”), optionally no more than about 100,000 cc and optionally no more than 50,000 cc.
Clause 53. The apparatus of clause 52, wherein the volume comprises a portion of a cassette, the portion corresponding to a volume of the cassette configured to hold a plurality of microscope slides.
Clause 54. The apparatus of clause 39, wherein the microscope, the microscope stage, the slide loader, a coverslipping station and a cassette are enclosed together within a housing.
Clause 55. The apparatus of clause 54, wherein the coverslipping station comprises a coverslip engagement structure to place a coverslip on the transparent flowable material.
Clause 56. The apparatus of clause 54, wherein the coverslipping station comprises a channel extending to an opening to place the transparent flowable material on the sample.
Clause 57. The apparatus of clause 54 wherein a gas is allowed to circulate among the microscope, the microscope stage, and an opening to place the flowable material on the sample, the slide loader, and the cassette and optionally wherein the gas comprises air.
Clause 58. The apparatus of clause 54, wherein the housing encloses a volume of no more than 200,000 cc, optionally no more than 100,000 cc, and optionally no more than 50,000 cc.
Clause 59. The apparatus of clause 39, wherein the transparent flowable material comprises an index matching oil comprising an index of refraction within a range from about 1.4 to about 1.6.
Clause 60. The apparatus of clause 39, wherein the one or more linkages comprises one or more of a motor, a gear, an actuator, a belt, a conveyor belt, a chain, a threaded member, a bolt, a nut, a pulley, a pull wire, a translation stage, a linear stage, a joint of a robotic arm, a robotic arm, or a gantry.
Clause 61. The apparatus of clause 39, wherein the one or more linkages comprises a first linkage coupled to a second linkage, the first linkage configured to position the microscope slide to place the transparent flowable material on the sample, the second linkage configured to place the slide on the microscope stage.
Clause 62. The apparatus of clause 61, further comprising a third linkage to couple the first linkage to the second linkage and transport the microscope slide between the first linkage and the second linkage.
Clause 63. The apparatus of clause 39, wherein the one or more linkages comprises a single linkage to remove the microscope slide from a cassette, place the transparent flowable material on the sample, place the microscope slide on the microscope stage, and place the microscope slide in the cassette.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A method of preparing a microscope slide for imaging a sample on the microscope slide, the method comprising:
placing a transparent flowable material on the sample while the slide is supported with one or more linkages coupled to a processor;
covering the sample with a coverslip; and
placing the microscope slide on a microscope stage with the one or more linkages coupled to the slide and the processor.

2. The method of claim 1, wherein the one or more linkages is coupled to a slide engagement structure configured to engage the microscope slide and move the microscope slide to the microscope stage with the one or more linkages, the slide engagement structure comprising one or more of an extension sized to fit under the slide, a slide support to couple to the slide, a suction source to couple to the slide, an electronically controlled gripper to hold the slide or a mechanical gripper to hold the slide.

3. The method of claim 1, wherein the microscope slide is placed on the microscope stage with a slide engagement structure coupled to the linkage and the flowable material is placed on the sample while the microscope slide is supported with the slide engagement structure.

4. The method of claim 3, wherein the coverslip is placed on the flowable material while the microscope slide is supported with the slide engagement structure.

5. The method of claim 1, wherein a pair of extensions engages the coverslip from opposite sides to move the coverslip into alignment with the microscope slide while the microscope slide is coupled to the linkage and optionally wherein the pair of extensions aligns the slide with one or more of the slide engagement structure or the microscope stage.

6. The method of claim 1, wherein the microscope slide is placed on the microscope stage at a first location of the microscope stage and a second slide that has been previously placed at a second location of the microscope stage is lifted from the microscope stage and placed in a cassette.

7. The method of claim 6, wherein the microscope slide is placed on the microscope stage at the first location with an extension beneath the microscope slide.

8. The method of claim 7, wherein there is relative lateral movement between the extension, the first slot and the second slot with the extension beneath the microscope slide.

9. The method of claim 7, wherein the extension is moved laterally from a first position beneath the microscope slide to a second position beneath the second microscope slide prior to lifting the second slide from the microscope stage.

10. The method of claim 7, wherein the microscope stage is moved laterally from a first position to a second position prior to lifting the second slide from the microscope stage.

11. The method of claim 1, wherein the flowable material is placed on the sample before the coverslip is placed on the flowable material and the flowable material is allowed to spread while the microscope slide is coupled to the linkage.

12. The method of claim 1, wherein the transparent flowable material is allowed to spread on the sample before imaging the sample.

13. The method of claim 12, wherein the flowable material is allowed to spread over the sample for a time within a range from about 5 seconds to about 120 seconds and optionally from about 10 seconds to about 60 seconds.

14. The method of claim 13, wherein the flowable material is allowed to spread over the sample for the time within the range after placing the coverslip on the flowable material.

15. The method of claim 13, wherein the time within the range comprises a first time before the coverslip is placed on the flowable material and a second time after the coverslip is placed on the flowable material.

16. The method of claim 1, wherein the coverslip is placed over the sample after placing a final amount of the flowable material on the sample.

17. The method of claim 16, wherein the coverslip is placed within about 0.5 seconds to about 30 seconds after placing the final amount on the sample and optionally within about 1 second to about 10 seconds.

18. The method of claim 1, wherein the transparent flowable material is placed on the sample with a channel extending to an opening and optionally wherein the channel extending to the opening comprises one or more of a needle or a nozzle.

19. The method of claim 18, wherein the transparent flowable material is sprayed on the sample.

20. The method of claim 18, wherein a gap extends between the sample and the opening to place the transparent flowable material on the sample.

21.-63. (canceled)
